(19) United States
(12) Patent Application Publication
(10) Pub. No.: US 2005/0028371 A1
(43) Pub. Date: Feb. 10, 2005

(54) Electric shaver

(75) Inventor: Kiyohiko Kakimoto, Matsumoto (JP)

Correspondence Address: KODA & ANDROLIA, 2029 CENTURY PARK EAST, SUITE 1430, LOS ANGELES, CA, 90067-3024, US

(73) Assignee: IZUMI PRODUCTS COMPANY

(21) Appl. No.: 10/911,453

(22) Filed: Aug. 4, 2004

(30) Foreign Application Priority Data
Aug. 6, 2003 (JP) 2003-287449

(51) Int. Cl. B26B 19/02

(52) U.S. Cl. 30/43.92; 30/34.1

(57) ABSTRACT

An electric shaver including a main body case provided therein with an inner cutter drive mechanism and a swingable shaver head installed on the main body case and has a plurality of reciprocating cutter units oriented parallel to each other in the lateral width direction of the main body case, wherein at least one of the reciprocating cutter units is raised or lowered; and by a combination of the raised or lowered position of one reciprocating cutter unit and the swung position of the shaver head, a selection of the operation mode that corresponds to one of at least three shaving areas including the area beneath the nose, the area beneath the jaw and the cheeks is made. Furthermore, mode selection switches for the operation modes are disposed above and below and on the left and right of a central main switch, the switches graphically depicting a human face.

### BACKGROUND OF THE INVENTION

1. Field of the Invention

The present invention relates to an electric shaver that is used to shave whiskers on the face and more particularly to an electric shaver in which a shaver head that includes a plurality of reciprocating cutter units is swingable with respect to the shaver main body case.

2. Prior Art

In one type of reciprocating type electric shaver, the shaver head that has a plurality of reciprocating cutter units is provided so that it can swing with respect to the main body casing, and a driving source (motor), a battery, etc. that constitutes a power supply are installed in this main body casing.

For example, Japanese Patent No. 2531474 discloses an electric shaver in which only the cutter portion swings back and forth about the vicinity of the upper end of the outer cutter.

In the shaver of Japanese Utility Model Application Laid-Open (Kokai) No. S59-7773, the shaver head is provided on the upper end of the shaver main body so that the shaver head can pivot in a tilting manner in the forward and rearward directions, and skirt walls that are formed in a circular arc shape centered on a pivoting center of the shaver head are formed on the front and rear edges of the lower end of the shaver head.

Moreover, the electric shaver disclosed in Japanese Patent Application Laid-Open (Kokai) No. 2001-334075 has a dial on the main body, so that the height of the cutters in the shaver head is adjusted by turning this dial.

With such electric shavers in which the cutter surface or shaver head is tiltable in accordance with the shaving location as disclosed in Japanese Patent No. 2531474 and Japanese Utility Model Application Laid-Open (Kokai) No. S59-7773, and also with such a shaver in which the height of the cutter can be varied in accordance with the thickness or hardness, etc. of the whiskers as shown in Japanese Patent Application Laid-Open (Kokai) No. 2001-334075, it is possible to make a fine adjustment in accordance with the shaving location, so that a good shaving effect is obtained.

In reciprocating type electric shavers, it has been attempted that a plurality of reciprocating cutter units are installed side by side, and at least one cutter unit protrudes or retracts in the vertical direction. In other words, it would be convenient to shave broad areas with a good efficiency using all of the cutter units in cases where soft, broad areas such as the cheeks, etc. are shaved, and it would be also convenient to perform shaving for narrow areas such as the area beneath the nose or the area beneath the jaw, etc. with some of the cutter units lowered so that a small number of cutters are concentrated in the small area.

However, in a shaver in which the inclination of the shaver head is varied in addition to the raising and lowering actions of the cutter units, the number of possible combinations of such switching operations increases, and thus operation of the shaver becomes tedious. Furthermore, it becomes difficult to select an appropriate combination in accordance with the shaving location. Moreover, raising and lowering of the cutter units and adjustment of the inclination of the shaver head are difficult to accomplish with one hand, so that the shaver is not convenient to use.

### SUMMARY OF THE INVENTION

The present invention is made in light of the facts described above, and the object of the present invention is to provide an electric shaver in which the operation of the shaver is simple by setting in advance combinations of the raised or lowered position of the cutter units and the inclination of the shaver head that are suited to shaving locations and in which the convenience of use of the shaver is enhanced so that the shaver can be operated with one hand.

The above object is accomplished by a unique structure of the present invention for an electric shaver that comprises a main body case provided therein with an inner cutter drive mechanism and a shaver head installed on the main body case, and the shaver head includes a plurality of reciprocating cutter units oriented parallel to each other in a lateral width direction of the main body case and is provided to swing about a swing axis that is in the lateral width direction of the main body case; and in the present invention at least one of the reciprocating cutter units is provided so as to be selectively raised and lowered; and with a combination of a raised or lowered position of at least one reciprocating cutter unit and a swing motion of the shaver head, one of operation modes that correspond to at least three shaving areas comprising an area beneath the nose, an area beneath the jaw, and an area of the cheeks is selected; and mode selection elements (switches) for making a selection of one of such three operation modes are disposed above, below and on the left and right sides of a central main switch.

In the present invention, combinations of the inclination (swinging position) of the shaver head and the vertical position of at least one of the reciprocating cutter units can be set beforehand and stored in memory in accordance with the shaving area (area beneath the nose, area beneath the jaw, or area of the cheeks), and one operation mode is selected by a mode selection element. Accordingly, there is no need to set the inclination of the shaver head and the height of the reciprocating cutter unit each time the shaving area is changed. As a result, the operation of the electric shaver is simple.

Furthermore, the mode selection elements are disposed so that they surround a central main switch; and the mode selection element above the main switch is designated for the shaving of the area beneath the nose, the mode selection element beneath the main switch is designated for the shaving of the area beneath the jaw, and the mode selection elements on the left and right of the main switch are designated for the shaving of the cheek areas. Accordingly, operation of the mode selection elements can be done easily with one hand; and since the correspondence between the mode selection elements and the shaving areas is clear and unmistakable, the convenience of use is high.

Though it is possible, in the present invention, to design so that the shaver head is caused to swing and the reciprocating cutter unit is caused to rise and lower by being mechanically linked to the mode selection elements, the present invention will be described for the structure in which the operation mode is selected by using an electrical actuator (motor) that causes the shaver head to swing and the reciprocating cutter unit to be raised and lowered. When an electrical actuator is used, then the mode selection elements are electrical switches.

Though the present invention will be described for the structure in which a single operation mode is used so as to select a desired shaving mode with a single common electrical actuator, it is possible, in the present invention, to design so that the shaver head and reciprocating cutter unit can be caused to swing and to be raised and lowered by separate electrical actuators. In the present invention, the swing motion of the shaver head and the rising and lowering motion of the reciprocating cutter unit are controlled by one driving body or a plurality of driving bodies. These driving bodies are memory means that store the inclination and vertical (raised and lowered) position of the shaver head and reciprocating cutter unit for each operation mode.

The driving body used in the present invention can be a single drive lever that is pivoted by an electric (stepping) motor. In this structure, the driving body is constructed so that the driving body pivots about an axis that is oriented in the lateral width direction of the main body case of the shaver; and this pivoting motion is transmitted to the shaver head via a swing lever so that the shaver head swings, and the reciprocating cutter unit is raised and lowered by a link lever that is raised and lowered by the pivoting motion of the drive lever.

It is preferable that the main switch and mode selection elements (or mode selection switches) be disposed on the front surface of the main body case of the shaver, so that the user is capable of making an one-handed operation with the thumb of the hand holding the main body case. It is also preferable that the main switch be disposed in the area that corresponds to the mouth of a graphically depicted human face and the mode selection elements (the mode selection switches) be disposed in the area beneath the nose, area beneath the jaw and cheeks of such a graphically depicted human face.

### BRIEF DESCRIPTION OF THE DRAWINGS

FIG. 1A is a front view of an electric shaver according to one embodiment of the present invention, FIG. 1B showing the manner of operation of the switches of the shaver;

FIG. 2 is an exploded perspective view of the shaver elements with some elements being omitted, mainly showing the elements of the shaver head of the shaver of the present invention;

FIG. 3 shows in cross section the internal structure of the essential portion of the shaver of the present invention;

FIG. 4 is a side view thereof;

FIG. 5 is an exploded perspective view of the head swing mechanism in the shaver of the present invention;

FIG. 6 is an exploded perspective view of the oscillator portion of the shaver of the present invention;

FIG. 7 is a side view of the shaver of the present invention in the cheek shaving mode;

FIG. 8 is a side view of the shaver of the present invention in the under-the-jaw shaving mode;

FIG. 9 is a side view of the shaver of the present invention in the under-the-nose shaving mode;

FIG. 10 illustrates the manner of shaving under the nose by the shaver of the present invention;

FIG. 11 illustrates the manner of shaving under the jaw by the shaver of the present invention;

FIG. 12 illustrates the manner of shaving on the cheeks by the shaver of the present invention;

FIG. 13 illustrates the manner of trimming by the shaver of the present invention;

FIG. 14 is an electrical circuit diagram used in the shaver of the present invention; and

FIGS. 15A through 15C illustrate the position sensors in operation in the shaver of the present invention.

### DETAILED DESCRIPTION OF THE INVENTION

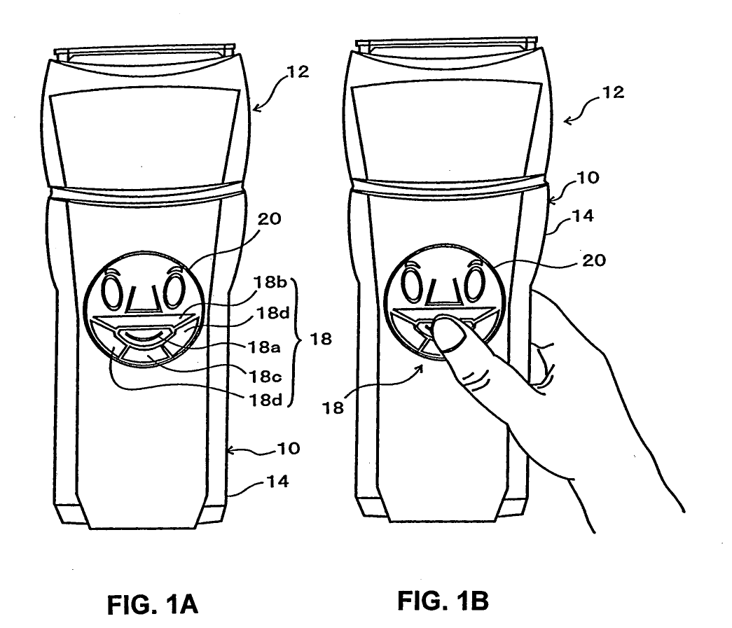

First, the main body of the shaver of the present invention will be described with reference to FIGS. 1 through 6.

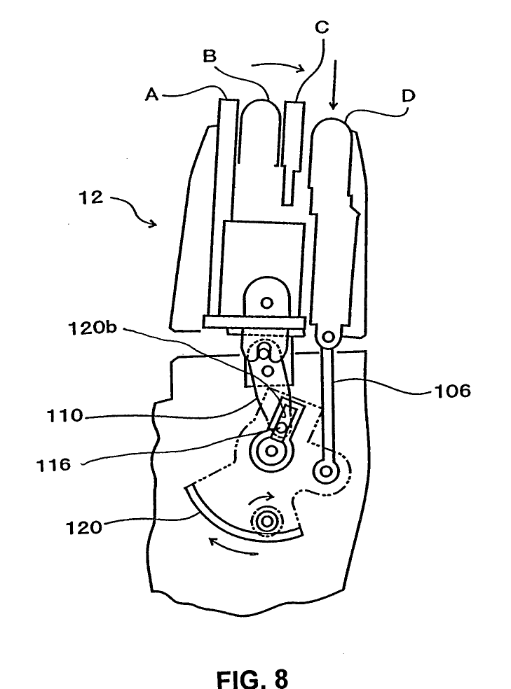

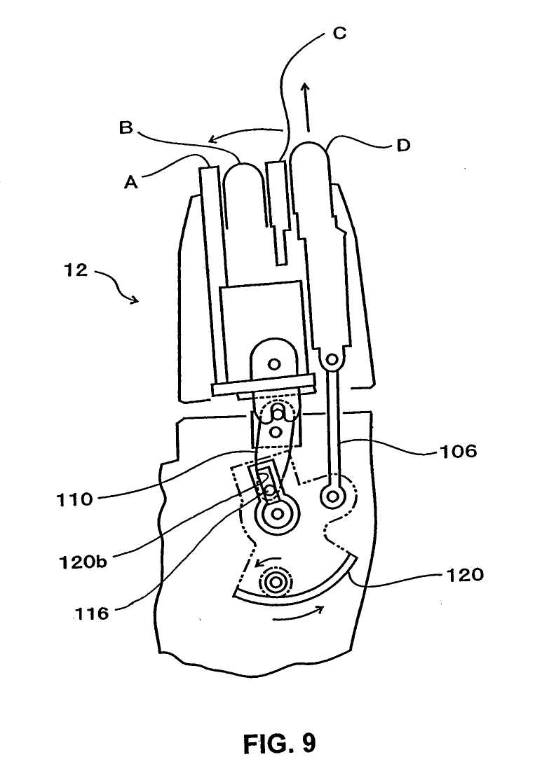

The electric shaver is comprised of a main body 10 and a shaver head 12. The main body 10 is long in the vertical direction and has a substantially oval shape when viewed from above (or in a top plan view), and the shaver head 12 is provided on the top portion of this main body 10 so that this shaver head 12 is swingable (see FIGS. 8 and 9, for instance) back and forth.

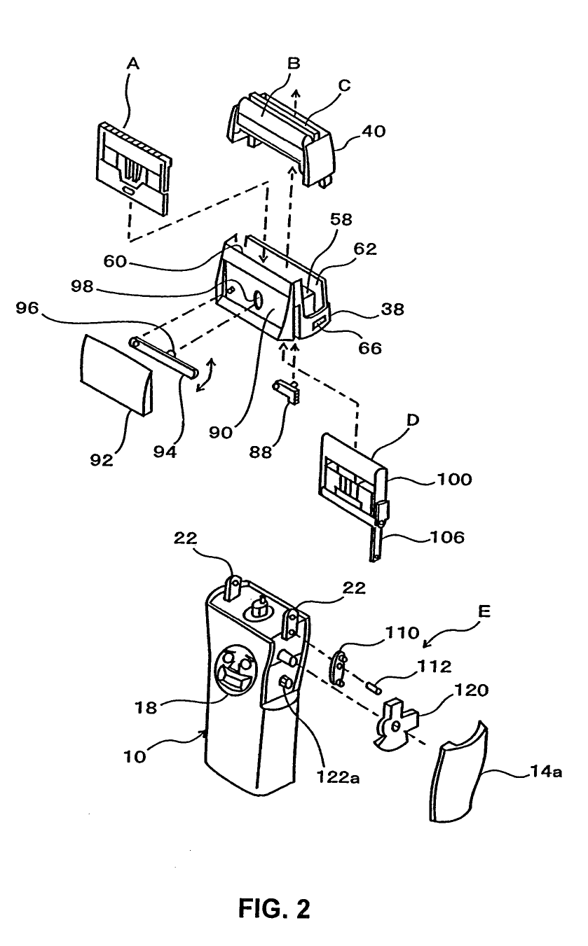

The main body 10 includes a main body case 14 and an inner cutter drive mechanism. The inner cutter drive mechanism is installed inside the main body case 14 and is comprised of an electric main motor 16, a power supply, etc. A switch group 18 is, as seen from FIG. 1A, provided on the front surface of the main body 10. In other words, the direction of the longer axis of the substantially oval shape (as seen in a plan view) of the main body case 14 is taken as a lateral width direction of the shaver, and the front surface (and rear surface) is provided in the lateral width direction; and the direction of the shorter axis of such an oval shape is taken as the front-rear direction of the shaver (see FIGS. 1A and 1B and FIG. 2).

As seen from FIG. 1A, the switch group 18 is comprised of a main switch 18a and four mode selection element or mode selection switches 18b, 18c, 18d and 18d. The main switch 18a is disposed in the position that corresponds to the mouth of a pattern 20 that depicts a model of a human face, and the four mode selection switches 18b, 18c, 18d and 18d are disposed so as to surround this main switch 18a. More specifically, the mode selection switch 18b is an under-the-nose mode selection switch 18b, and it is disposed above the main switch 18a so as to correspond to the area under the nose of the human model face; the mode selection switch 18c is an under-the-jaw mode selection switch 18c, and it is disposed beneath the main switch 18a so as to correspond to the area under the jaw of the human model face; and the mode selection switches 18d are cheek mode selection switches 18d, and they are disposed on the left and right sides of the main switch 18a so as to correspond to both cheeks of the human model face.

The reference numerals 22, as seen from FIG. 2, are head supporting plates 22 provided in the main body case 14. The head supporting plates 22 are separated in the direction of width of the shaver main body 14 and face each other, and they are disposed so that these head supporting plates 22 protrude from the upper end surface of the main body case 14.

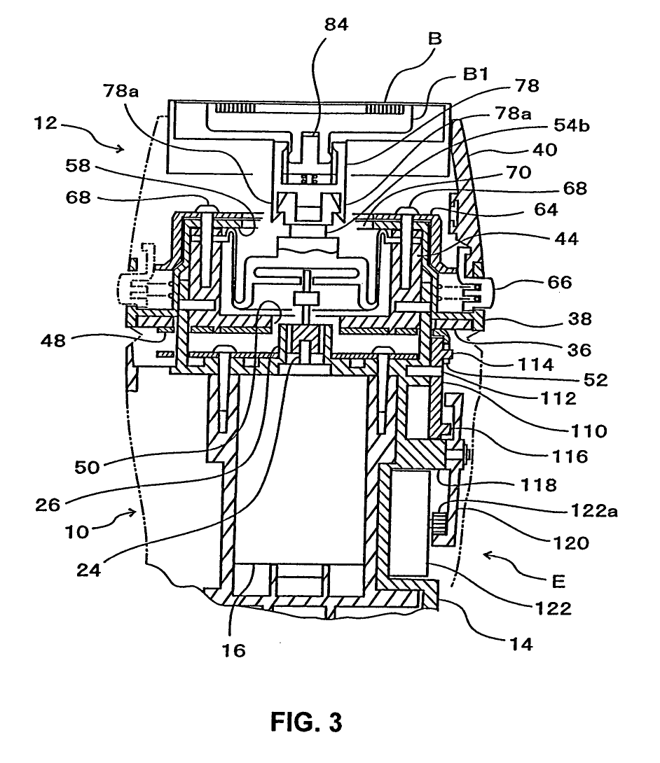

As seen from FIG. 3, the output shaft 24 of the main motor 16 protrudes vertically upward at a mid point between the two supporting plates 22. The output shaft 24 protrudes into the interior of a cylindrical guide 26 that is formed as an integral part of the main body case 14.

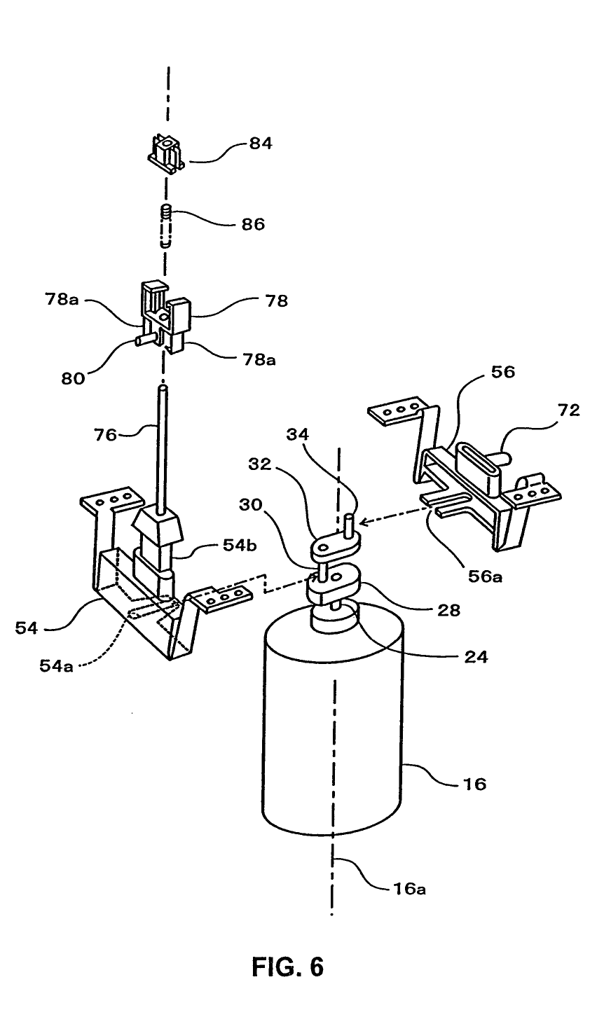

As shown in FIG. 6, a first joint 28 that is set in the cylindrical guide 26 in a rotatable fashion is coupled to the output shaft 24 so that the output shaft 24 and the first joint 28 are rotated together about the rotational axial line 16a of the output shaft 24. The rotational axial line 16a of the output shaft 24 and the rotational center of the first joint 28 are set to be coincide with each other.

In addition, a second joint 32 is provided above the first joint 28 via a first eccentric pin 30, and a second eccentric pin 34 is provided so as to protrude from the upper end of the second joint 32. The first and second eccentric pins 30 and 34 are parallel to the output shaft 24 and are located in symmetrical positions on either side of the rotational axial line 16a of the output shaft 24.

The shaver head 12 will be described next.

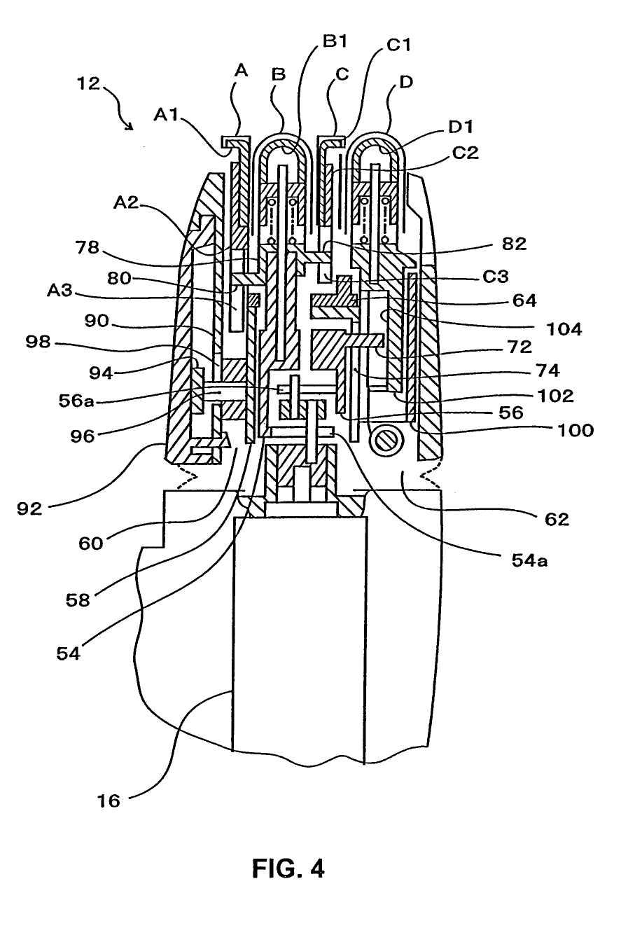

The shaver head 12 includes, as best seen from FIG. 4, a plurality of reciprocating cutter units A through D which are disposed parallel to the lateral width (left-right) direction of the shaver main body case 14. More specifically, the shaver head 12 has a trimming cutter unit A, a main cutter unit B, a rough shaving cutter unit C and a movable cutter unit D in that order from the front surface side to the rear surface side of the shaver head 12 as shown in FIG. 4. The shaver head 12 is held by the supporting plates 22 of the main body case 14 so that it is free to swing in the forward-rearward direction or back and forth (as shown by curved arrows in FIGS. 8 and 9).

Furthermore, the shaver head 12 is, as seen from FIG. 3, comprised of a head base 36, a base lower cover 38 and a base upper cover 40.

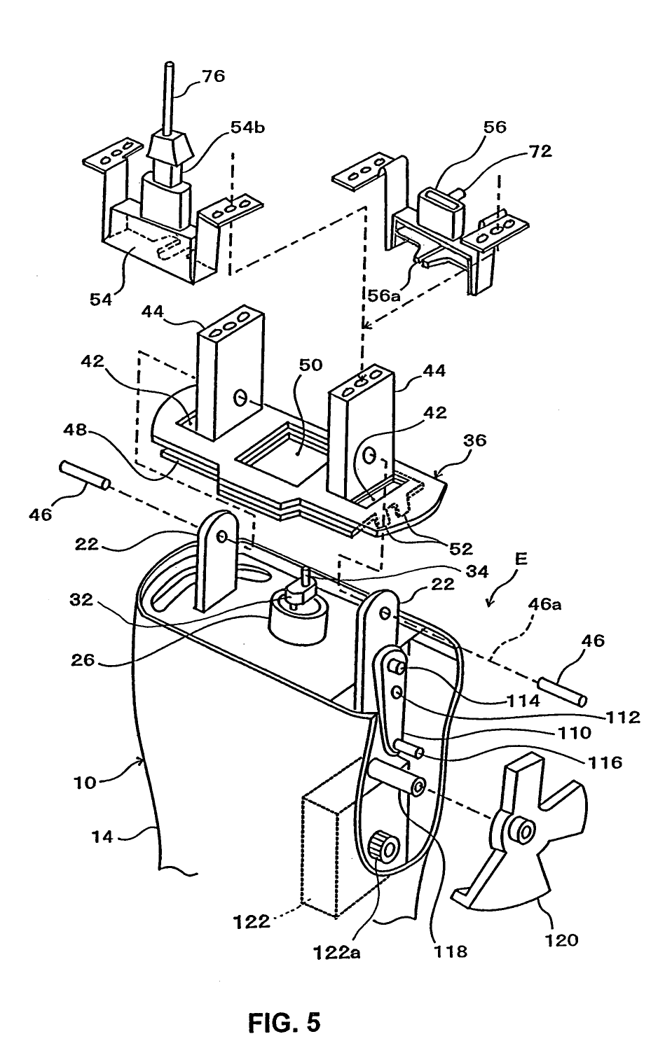

As shown in FIG. 5, the head base 36 is formed with side openings 42 so that the head supporting plates 22 of the main body case 14 pass there the side openings 42, and the head base 36 is further provided with upright protruding pieces 44 which protrude upward near the side openings 42. The upright protruding pieces 44 are connected to the head supporting plates 22 by supporting shafts 46 so that these upright protruding pieces 44 (and thus the head base 36 as well) are swingable. As a result, the shaver head 12 swings about a straight swing axis line 46a that corresponds to the supporting shafts 46 and is parallel to the lateral width direction of the main body case 14.

A metal plate 48 is fastened by screws (not shown) to the undersurface of the head base 36. A central opening 50 through which the cylindrical guide 26 of the main body case 14 passes is formed near the center of the head base 36. Of course, openings that correspond to the side and central openings 42 and 50 of the head base 36 are formed in the metal plate 48 as well so that the head supporting plates 22 and the cylindrical guide 26 pass through them. One end (the right end in the shown embodiment) of the metal plate 48 is, as seen from FIG. 5, bent downward at a point located further to the outer side of the right side head supporting plate 22 (that is in the side opening 42) with respect to the direction of width of the main body case 14, and this bent part forms engaging claws 52 that face downward and is in a bifurcated shape. The engaging claws 52 engage with a swing lever 110 (described later).

A pair of oscillators (front and rear oscillators) 54 and 56 are held on the upper end surfaces of the upright protruding pieces 44. As seen from FIGS. 5 and 6, both side (left and right) end portions of these oscillators 54 and 56 are held on the upper end surfaces of the upright protruding pieces 44 so that the oscillators can move laterally (or sideways to the left and right in FIG. 1A) independently of each other. As seen from FIG. 6, the front oscillator 54 installed on the front surface side of the main body case 14 has a slit 54a (which is long in the forward-rearward direction) that engages with a first eccentric pin 30; and the rear oscillator 56 installed on the back surface side of the main body case 14 has a slit 56a (which is long in the forward-rearward direction) that engages with a second eccentric pin 34.

With these oscillators 54 and 56, when the output shaft 24 of the main motor 16 rotates, the first and second eccentric pins 30 and 34 respectively cause the oscillators 54 and 56 to oscillate to the left and right or sideways in FIG. 1A. The respective amplitudes of the oscillation of the two oscillators 54 and 56 are determined by the amounts of eccentricity of the eccentric pins 30 and 34; and these amounts of eccentricity are set at dimensions that are optimal to prevent vibrations by taking, for instance, the weight balance of the parts that are caused to oscillate into account.

With the oscillators 54 and 56 held on the upright protruding pieces 44, the head lower cover 38 is set on the head base 36. As shown in FIG. 3, the head lower cover 38 has (on the inside) a box-form portion 58 that envelops the upright protruding pieces 44 from above (see also FIGS. 2 and 4); and as seen from FIGS. 2 and 4, an accommodating space 60 for the trimming cutter unit A is formed on the front side of this box-form portion 58, and an accommodating space 62 for the movable cutter unit D is formed on the back side of this box-form portion 58.

Next, the oscillator portion that is accommodated in the box-form portion 58 will be described.

As seen from FIG. 3, an inner cover 64 is set on the box-form portion 58 of the head lower cover 38. The inner cover 64 functions as a spacer that positions the reciprocating cutter units B, C, etc. The inner cover 64 surrounds the upper surface and side (left and right) surfaces of the box-form portion 58, and the side (left and right) ends thereof extend horizontally and form return spring chambers for attachment and detachment keys 66 that are mounted on the head lower cover 38. Screws 68 are screwed into the upright protruding pieces 44 from above after the oscillators 54 and 56 are set on the upright protruding pieces 44 of the head base 36 and the head lower cover 38 and inner cover 64 are installed on the oscillators 54 and 56.

The box-form portion 58 and inner cover 64 are provided their upper surfaces with openings 70, so that an upright protruding piece 54b (see FIGS. 5 and 6) integrally formed on the front oscillator 54 protrudes upward through the openings 70. In addition, as seen from FIG. 4, an opening 74 is formed in the back wall of the box-form portion 58 so that a drive pin 72 of the rear oscillator 56 protrudes rearward. As will be described below, the drive pin 72 drives the inner cutter D1 of the movable cutter unit D that can be raised and lowered.

The front oscillator 54 has an oscillator shaft 76 that protrudes vertically from the upper end of the upright protruding piece 54b. As seen from FIG. 6, a driving block 78 through which the oscillator shaft 76 passes is fastened to the upper end of the upright protruding piece 54b by a pair of engaging claws (left and right engaging claws) 78a. A drive pin 80 which protrudes toward the front and a drive pin 82 (see FIG. 4) which protrudes toward the back are formed as integral parts of the driving block 78. As will be described below, the drive pins 80 and 82 drive the inner cutters of the trimming cutter unit A and of the rough shaving cutter unit C.

The reciprocating cutter units A, B, C and D used in the shaver of the present invention will be described below.

As seen from FIG. 6, an inner cutter holding block 84 to which the inner cutter B1 of the main cutter unit B (see FIG. 4) is fastened is held on the upper end of the oscillator shaft 76 so that the inner cutter holding block 84 is free to move vertically, upward and downward. The inner cutter holding block 84 is endowed with a return habit in the upward direction by a coil spring 86 that is compressed between the inner cutter holding block 84 and the driving block 78. With this coil spring 86, the inner cutter B1 of the main cutter unit B is pressed against the inside surface (undersurface) of a circular arc form outer cutter (i.e., a cutter which has a circular arc shape as seen in the side view of FIG. 4) of the cutter unit B.

As shown in FIG. 2, the trimming cutter unit A is provided in the accommodating space 60 of the head lower cover 38 from above. The vertical (raised or lowered) position of this trimming cutter unit A is altered by a manual operation element 88 that is disposed on the right side surface of the head lower cover 38. More specifically, a trimming lever 94 which is pivot-supported on a front wall 90 which is on the front surface side of the accommodating space 60 is installed between the front wall 90 and a front surface cover 92. The swing end of this trimming lever 94 is engaged with the manual operation element 88, and a pin 96 that protrudes at a laterally mid point of this trimming lever 94 passes through a slot 98 formed in the front wall 90 and engaged with the trimming cutter unit A. A click mechanism (not shown in the drawings) that holds the trimming cutter unit A in a raised (protruding) position or a lowered (accommodated) position is disposed on the trimming lever 94.

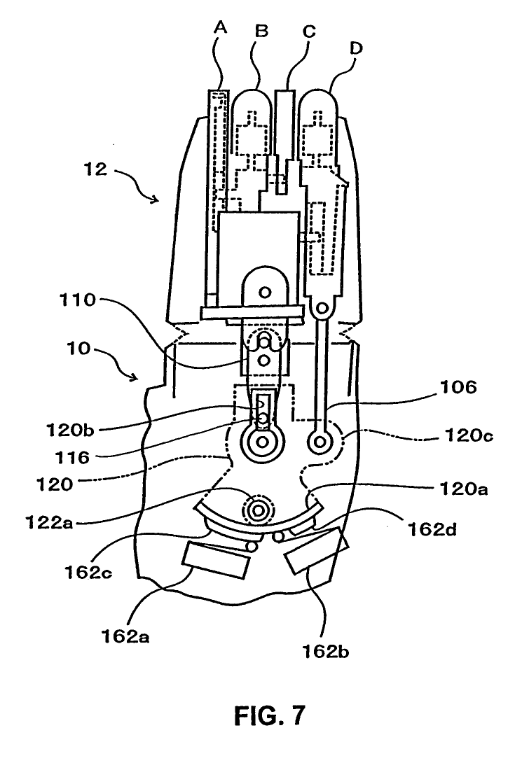

With the structure described above, when the user raises the manual operation element 88 with the thumb of the hand gripping the main body 10, the swing end of the trimming lever 94 pivots upward; and the pin 96 of the trimming lever 94 raises the trimming cutter unit A. FIG. 13 shows the raised trimming cutter unit A. On the other hand, when the user lowers the manual operation element 88, the trimming cutter unit A is lowered and positioned at substantially the same height as the main cutter unit B and rough shaving cutter unit C. The lowered trimming cutter unit A is shown in FIGS. 7 through 12. It is advisable that the shaver head 12 be placed in the reference (or normal or non-swing) position that is shown in FIG. 7 during this trim shaving.

The inner cutter A1 of the trimming cutter unit A and the inner cutter C1 of the rough shaving cutter unit C are, as seen from FIG. 4, respectively held with an upward elastic return habit on the upper portions of the thin plates A2 and C2 that are movable in the direction of width of the main body case 14. Longitudinal slits A3 and C3 are respectively formed in the thin plates A2 and C2, and the drive pins 80 and 82 of the driving block 78 are engaged with these slits. Accordingly, the swing motion of the front oscillator 54 that is caused to swing sideways or in the left and right directions in FIG. 1A by the main motor 16 is transmitted to the inner cutters A1 and C1 via the driving block 78.

Furthermore, the movable cutter unit D is built in a holder 100. An inner cutter D1 which is formed substantially in the shape of a circular arc as seen in the side view as seen from FIG. 4 is fastened to the upper portion of the holder 100, and a driving block 102 is mounted on the lower inside portion of the holder 100 so that the driving block 102 is movable sideways or to the left and right in FIG. 1A. An oscillator shaft is installed in a perpendicularly upright attitude in the center (with respect to the left-right direction) of the driving block 102, and the inner cutter D1 is held here with an upward elastic return habit. Since this structure is similar to that of the above-described main cutter unit B, a further description of the movable cutter unit D is omitted.

A longitudinal slit 104 is formed in the center (with respect to the left-right, lateral direction) of the driving block 102, and the drive pin 72 of the rear oscillator 56 is engaged with this slit 104. Accordingly, the swing motion of the rear oscillator 56 that is caused in left and right directions in FIG. 1A by the main motor 16 is transmitted to the driving block 102 via the drive pin 72 and slit 104, so that the inner cutter D1 swings sideways or in the left and right directions. Furthermore, a link lever 106 is held, by a horizontal shaft of the left-right direction, on the lower edge of the holder 100 so that the link lever 106 is free to swing in the forward-rearward direction. The entire body of the movable cutter unit D (together with the holder 100) is raised and lowered via this link lever 106.

The shaver head 12 which includes the four reciprocating cutter units A through D described above can be separated into the head upper cover 40 and head lower cover 38 by means of attachment and detachment keys 66 (see FIG. 3) disposed on the left and right sides of the head lower cover 38. When the head upper cover 40 is separated from the head lower cover 38, the trimming cutter unit A and the inner cutters B1, C1 and D1 of the other cutter units B, C and D remain in the head lower cover 38; and the outer cutters of the main cutter unit B, rough shaving cutter unit C and movable cutter unit D stay with the separated head upper cover 40 and can be cleaned. Since the inner cutters B1, C1 and D1 that remain in the head lower cover 38 are exposed and not covered by the corresponding outer cutters, these inner cutters can be also easily cleaned.

Next, the operation mode switching mechanism E that controls the raising and lowering of the movable cutter unit D and the inclination of the shaver head 12 will be described.

As seen from FIG. 2, the operation mode switching mechanism E is accommodated inside the side surface cover 14a that is attached to the right side of the main body case 14. The shaver head 12 is as described above held by the supporting plates 22 provided in the main body case 14 so that this shaver head 12 is swingable in the forward-rearward direction; and as seen from FIG. 5 a swing lever 110 is held by a swing lever shaft 112 that is oriented in the left-right direction (see FIG. 3) on the lower outside surface of the right-side supporting plate 22.

The swing lever 110 has upper and lower pins 114 and 116 on either side (upper and lower sides) of the swing lever shaft 112. The upper pin 114 engages from below with the engaging claws 52 (see FIG. 5) of the head base 36 of the shaver head 12. A bearing shaft 118 is disposed on the main body case 14 so as to protrude rightward from beneath the swing lever 110. A drive lever 120 that constitutes the driving body of the present invention is shaft-supported on the bearing shaft 118. This drive lever 120 is rotated by a stepping motor 122 which is a secondary motor and is provided in the main body case 14 beneath the bearing shaft 118.

More specifically, as seen from FIG. 3, a circular arc form internal-tooth gear 120a is formed on the lower part of the drive lever 120, and a pinion gear 122a fastened to the output shaft of the secondary motor 122 is engaged with this internal-tooth gear 120a. A cam groove 120b (see FIG. 7) which opens toward the pin 116 of the swing lever 110 and into which this pin 116 is inserted is formed in the upper portion of the drive lever 120. The cam groove 120b is long in the radial direction from the bearing shaft 118, and it is positioned vertically when the shaver is in the cheek shaving mode (FIG. 7) in which the shaver head 12 is in the normal (reference) position. The drive lever 120 has an arm portion 120c that extends rearward as shown in FIG. 7, and the lower end of the link lever 106 of the movable cutter unit D is connected to this arm portion 120c.

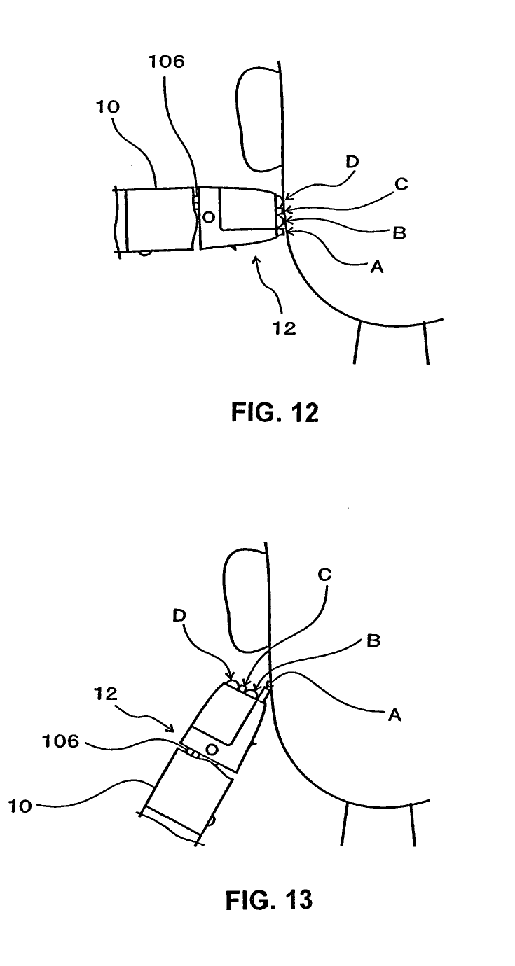

When the drive lever 120 is in the normal or reference position shown in FIG. 7, the shaver head 12 is completely upright, and the movable cutter unit D is in a normal or reference position which is at the same height as the other cutter units A, B and C. This normal or reference position is suitable for shaving the cheeks as shown in FIG. 12.

When the motor 122 is turned on and driven in one direction so that the drive lever 120 is accordingly pivoted in the clockwise direction (as seen in the side view) as shown in FIG. 8, the pin 116 of the swing lever 110 is guided by the cam groove 120b, and the swing lever 110 pivots counterclockwise. As a result, the shaver head 12 swings in the clockwise direction, and the link lever 106 is pulled downward so that the movable cutter unit D is lowered; and thus, the shaver is brought into a mode that is suitable for shaving the area beneath the jaw as shown in FIG. 11.

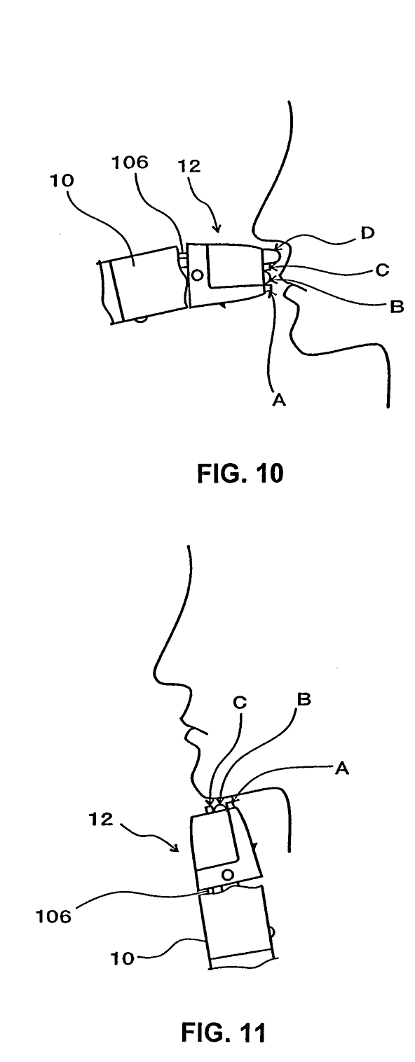

When the motor 122 is driven in the opposite direction so that the drive lever 120 is accordingly pivoted in the counterclockwise direction as shown in FIG. 9, the pin 116 of the swing lever 110 is guided by the cam groove 120b, and the swing lever 110 pivots clockwise. As a result, the shaver head 12 swings in the counterclockwise direction, and the link lever 106 is pushed upward so that the movable cutter unit D is raised; and thus, the shaver is brought into a mode that is suitable for shaving the area beneath the nose as shown in FIG. 10.

In the shown embodiment above, a single driving lever (driving body) 120 is employed; however, the present invention is applicable to a shaver that includes a plurality of driving levers (driving bodies) for the purpose of raising and lowering a plurality of inner cutter units independently and swing the shaver head back and forth.

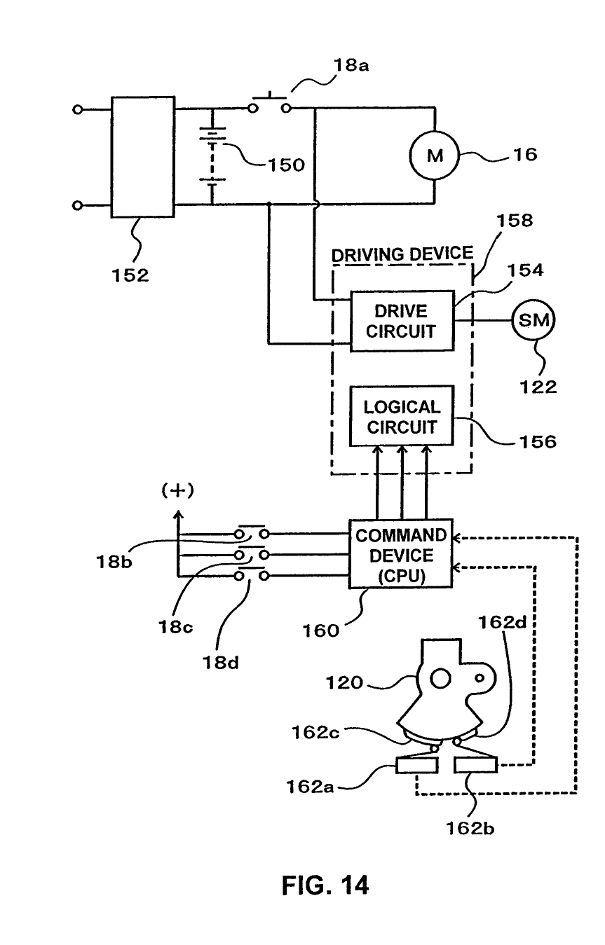

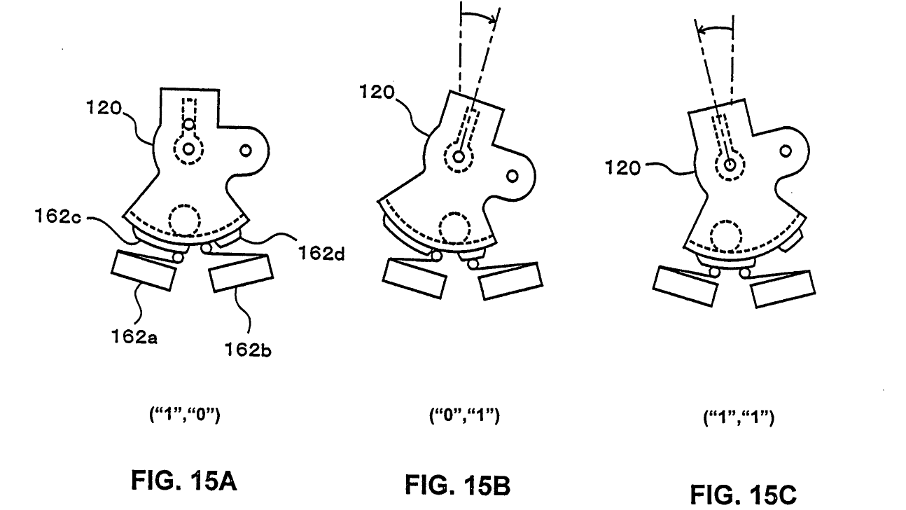

FIGS. 14 and 15 show the manner of controlling the stepping (secondary) motor 122.

In FIG. 14 which is a control circuit for the stepping motor 122, the reference numeral 150 is a rechargeable secondary cell, and 152 is a charging circuit, these parts being installed in the main body case 14. The charging circuit 152 subjects alternating current supplied from the outside (e.g., from a commercial power supply, etc.) to voltage transformation and rectification, and charges the cell 150. The main motor 16 is a permanent magnet type direct-current motor that constitutes an actuator is connected to the cell 150 via the main switch 18a.

The stepping motor 122 is driven in the forward and reverse directions by a driving device 158 that is comprised of a logical circuit 154 and a drive circuit 156. A command device 160, which is a micro-computer (CPU), varies the pulse oscillation frequency based upon the signals from the mode selection switches 18b, 18c and 18d (see FIG. 1A) and signals from position sensors 162a and 162b that detects the position of the drive lever 120 and sends forward or reverse driving signals and stopping signals to the logical circuit 156. Based upon these signals supplied by the command device 160, the logical circuit 156 generates and distributes pulse signals or stop signals that are suited to the form, number of phases and excitation system, etc. of the stepping motor 122. The drive circuit 154 receives these signals and causes an exciting current to flow to the stepping motor 122 using electric power supplied from the cell 150.

The position sensors 162a and 162b will be described below with reference to FIGS. 15A through 15C.

In the shown embodiment, the drive lever 120 stops in three positions that correspond to three different operation modes. Consequently, it is necessary to detect at least three positions; and thus two position sensors 162a and 162 which are micro-switches are provided, and these two position sensors or micro-switches 162a and 162 are switched on or off by contact with or separation from protruding parts 162c and 162d disposed on the outer circumference that is the other side of the internal-tooth gear 120a of the drive lever 120. In the shown embodiment, the protruding part 162c is longer than the protruding part 162d.

In the normal or reference position of the shaver head 12 shown in FIG. 7 in which the shaver is in the cheek shaving mode, the switch 162a is “on” (or “1”) and the switch 162b is “off” (or “0”) as shown FIG. 15A. In the state shown in FIG. 8 in which the drive lever 120 is pivoted clockwise so that the shaver is in the under-the-jaw shaving mode, the switches 162a and 162b are, as shown in FIG. 15B, respectively “off” and “on” (or “0” and “1”). In the state shown in FIG. 9 in which the drive lever 120 is pivoted counterclockwise and thus the shaver is in the under-the-nose shaving mode, the witches 162a and 162b are respectively “on” and “on” (or “1” and “1”) as shown in FIG. 15C. The command device 160 judges the set positions of the drive lever 120 based upon the signals from these switches 162a and 162b.

1. An electric shaver comprising a main body case provided therein with an inner cutter drive mechanism and a shaver head installed on said main body case, wherein said shaver head includes a plurality of reciprocating cutter units oriented parallel to each other in a lateral width direction of said main body case and is disposed to swing about an axis which is in said lateral width direction of said main body case; and wherein:
at least one of said reciprocating cutter units is selectively raised and lowered, thus allowing a selection of operation modes corresponding to at least three shaving areas comprising an area beneath the nose, an area beneath the jaw, and an area of the cheeks to be made by a combination of a raised or lowered position of said at least one reciprocating cutter unit and a swing motion of said shaver head, and mode selection elements for selection of said operation modes are disposed so as to surround a central main switch.

2. The electric shaver according to claim 1, wherein:
a driving body, which causes said shaver head to swing and which raises and lowers at least one of said reciprocating cutter units, and an electrical actuator, which operates said driving body, are provided in said main body case; and
said mode selection elements are electrical switches that operate said electrical actuator.

3. The electric shaver according to claim 2, wherein said driving body is a drive lever that is pivotable, and said electrical actuator is a motor that drives said drive lever in a pivoting motion.

4. The electric shaver according to claim 3, wherein said drive lever is pivotable about an axis which is in said lateral width direction of said main body case, so that said shaver head swings via a swing lever by a pivot motion of said drive lever and so that at least one of said reciprocating cutter units is raised and lowered via a link lever that is raised and lowered by said pivot motion of said drive lever.

5. The electric shaver according to claim 1, wherein said main switch and said mode selection elements are disposed on a front surface of said main body case, and said main switch and said mode selection elements are operable by a thumb of one hand of a user holding said main body case.

6. The electric shaver according to claim 5, wherein a pattern of a graphically depicted human face is provided on said front surface of said main body case, said main switch is disposed in a position that corresponds to mouth of said human face, and said mode selection elements for respective positions of an area beneath the nose, an area beneath the jaw and an area of the cheeks are disposed above and below and on left and right surrounding said main switch.
